(19) United States
(12) Patent Application Publication
(10) Pub. No.: US 2011/0060523 A1
(43) Pub. Date: Mar. 10, 2011

(54) Method of utilizing a personal navigation device to suggest alternate routes being identified by recognizable street names

(76) Inventor: Peter James Baron, Auckland (NZ)

(21) Appl. No.: 12/556,579

(22) Filed: Sep. 10, 2009

(51) Int. Cl. G01C 21/34; G08G 1/123; G10L 15/00; G06F 3/041

(52) U.S. Cl. 701/224; 340/995.1; 701/117; 704/231; 704/E15.001; 345/173

(57) ABSTRACT

A method of presenting alternate routes to a user of a personal navigation device includes providing navigation instructions for guiding the user on an original route selected by the user, receiving and analyzing dynamic traffic data, determining the presence of a first alternate route according to the dynamic traffic data, the first alternate route potentially requiring a shorter travel time than the original route, and prompting the user with a choice of following the first alternate route, wherein the first alternate route is described using the name of at least one street associated with the first alternate route.

### BACKGROUND OF THE INVENTION

1. Field of the Invention

The invention relates to a personal navigation device, and more particularly, to a personal navigation device that uses street names for informing a user about alternate routes for informing the user about available detour options.

2. Description of the Prior Art

Global Positioning System (GPS) based navigation devices are well known and are widely employed as in-car navigation devices. Common functions of a navigation device include providing a map database for generating navigation instructions that are then shown on a display of the navigation device. These navigation devices are often mounted on or in the dashboard of a vehicle using a suction mount or other mounting means.

The term “navigation device” refers to a device that enables a user to navigate to a pre-defined destination. The device may have an internal system for receiving location data, such as a GPS receiver, or may merely be connectable to a receiver that can receive location data. The device may compute a route itself, or communicate with a remote server that computes the route and provides navigation information to the device, or a hybrid device in which the device itself and a remote server both play a role in the route computation process. Portable GPS navigation devices are not permanently integrated into a vehicle but instead are devices that can readily be mounted in or otherwise used inside a vehicle. Generally (but not necessarily), they are fully self-contained—i.e. include an internal GPS antenna, navigation software and maps and can hence plot and display a route to be taken.

Personal navigation devices strive to guide users on the best possible route in order to minimize the time needed to travel from one point to another. When a user selects a destination location, the personal navigation device selects a route that is believed to be the fastest out of all of the options currently available. Real-time traffic information may be considered at the time the route is selected, which may affect the routing decisions.

Once a route has been selected, the personal navigation device starts to provide navigation instructions to guide the user to the destination location. Occasionally, after the user has already started following the original route, the personal navigation device may become aware of additional information such as updated traffic data that affects the original route that the user is traveling on. For example, there could be a major car accident several miles ahead of the user on the same road that the user is driving on. In this case, the personal navigation device can suggest alternate routes to the user in order to allow the user to have a chance to avoid the congested area. As another example, the personal navigation device may become aware of time-sensitive conditions such as a ferry time table or school class times indicating the start and end of a day's classes. When time is approaching an important time such as when classes are over for the day at a nearby school, traffic around the school area may become quite congested. Thus, the personal navigation device may wish to suggest an alternate route that avoids these congested areas.

The conventional way for the personal navigation device to present alternate routes to the user is to show a map of both the original route and the alternate route with the alternate route being highlighted. One or more maps can be shown to the user, each having a different alternate route shown. The user is then given a chance to select which of the alternate routes, if any, should be followed.

Unfortunately, the prior art approach for showing alternate routes to the user requires considerable load to be put on the processor of the personal navigation device in order to generate the maps for the various alternate routes. In addition, it is difficult for the user to study the maps showing the alternate routes while the user is driving. This makes it difficult for the user to quickly and safely make an informed decision about which alternate route should be selected. Furthermore, this approach provides the user with no useful information that is presented in a way that is easy to understand, for example, “We suggest a detour of X miles that may save you Y minutes”.

### SUMMARY OF THE INVENTION

It is therefore one of the primary objectives of the claimed invention to provide a method and related personal navigation device for suggesting alternate routes by identifying the alternate routes by the names of key streets in the alternate routes.

According to an exemplary embodiment of the claimed invention, a method of presenting alternate routes to a user of a personal navigation device is disclosed. The method includes providing navigation instructions for guiding the user on an original route selected by the user, receiving and analyzing dynamic traffic data, determining the presence of a first alternate route according to the dynamic traffic data, the first alternate route potentially requiring a shorter travel time than the original route, and prompting the user with a choice of following the first alternate route, wherein the first alternate route is described using the name of at least one street associated with the first alternate route.

According to another exemplary embodiment of the claimed invention, a personal navigation device for presenting alternate routes to a user is disclosed. The personal navigation device includes routing software for providing navigation instructions for guiding the user on an original route selected by the user, a processor for controlling operation of the personal navigation device, receiving and analyzing dynamic traffic data, and determining the presence of a first alternate route according to the dynamic traffic data, the first alternate route potentially requiring a shorter travel time than the original route, and a user interface for prompting the user with a choice of following the first alternate route, wherein the first alternate route is described using the name of at least one street associated with the first alternate route.

It is an advantage that users can quickly learn of the various alternate routes available and make a selection without needing to study the various alternate routes in great detail. Not only does this save the user time, but it allows the user to maintain focus on the road, thereby allowing the user to safely choose an alternate route when the original route becomes less desirable.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a personal navigation device according to the present invention.

FIG. 2 shows a map illustrating an alternate route that offers a temporary detour off of an original route taken by the user of the personal navigation device.

FIG. 3 is a flowchart illustrating providing alternate navigation instructions according to the present invention method.

### DETAILED DESCRIPTION

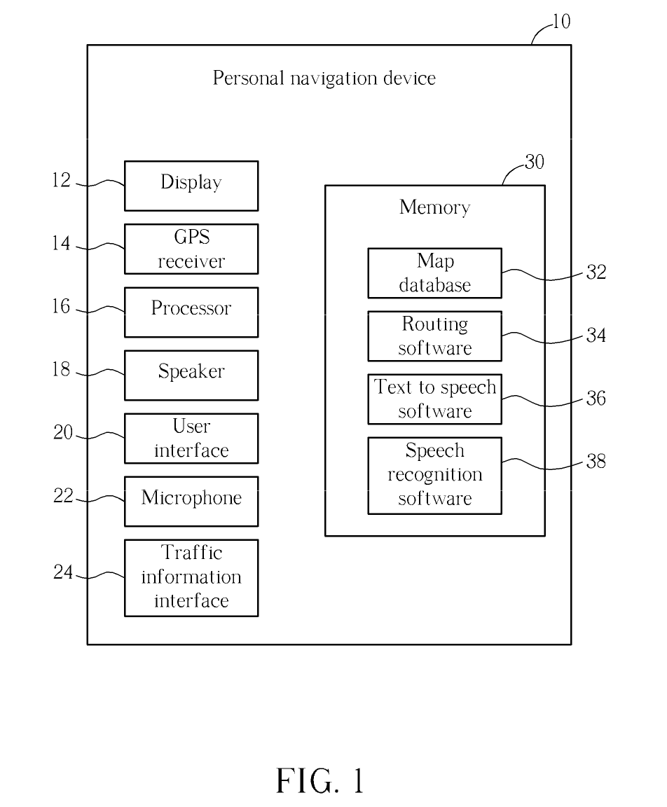

Please refer to FIG. 1. FIG. 1 is a block diagram of a personal navigation device 10 according to the present invention. The personal navigation device 10 contains a display 12 which can be a touch sensitive display, a GPS receiver 14 for receiving the current coordinates of the personal navigation device 10, a processor 16 for controlling operation of the personal navigation device 10, a speaker 18, a user interface 20, a microphone 22, a traffic information interface 24, and a memory 30. The memory 30 is used to store a map database 32 containing map data and points of interest. The memory 30 also stores routing software 34, text to speech software 36, as well as speech recognition software 38.

When the user selects a destination location using the user interface 20 of the personal navigation device 10, the routing software 34 generates the quickest route to get the user to the destination location. Dynamic traffic information can be received through the traffic information interface 24 such as through FM radio in order to let the routing software 34 make the best decision about which route is fastest. Afterwards, the routing software 34 presents the route to the user, and the user begins following this original route.

After the user has begun traveling on the original route, new traffic data may be received through the traffic information interface 24 that indicates there is problem with traffic ahead on the original route that the user is driving on. The routing software 34 will learn of the specific conditions of the traffic condition, such as whether it is due to a traffic accident, a road closure, or if it is just a slight slowdown in traffic. After this information has been obtained, the routing software 34 can begin to search for other alternate routes that may provide a faster way for the user to get to the destination location. The routing software 34 uses all of the best information currently available to it in order to determine which alternate routes are fastest. This information includes posted speed limits on roads, road types, traffic conditions, etc. Once one or more alternate routes have been found, the alternate routes are identified by the street names of major streets that the alternate route follows.

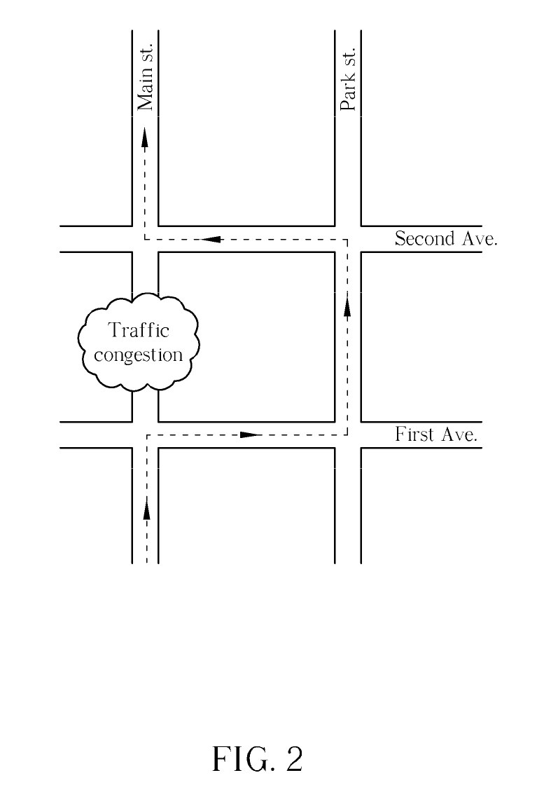

Please refer to FIG. 2. FIG. 2 shows a map illustrating an alternate route that offers a temporary detour off of an original route taken by the user of the personal navigation device 10. In this example, the user is traveling on Main St. when the personal navigation device 10 receives a notice through the traffic information interface 24 about traffic congestion up ahead. When the need for an alternate route becomes apparent, the routing software 34 can make use of the text to speech software 36 and the speaker 18 to read the names of some of the street names contained in the alternate routes. For example, the user could be issued the following prompt: “Heavy traffic up ahead on Main St. Do you want to detour via First Ave. and Park St.?” Thus, without having to look at the display 12 of the personal navigation device 10, the user can instantly be given enough information to decide whether to take this alternate route or not. Of course, the same prompt can be displayed on the display 12 instead of or in addition to producing an audible prompt with the speaker 18.

In this example, two street names are given to describe the detour route, “First Ave.” and “Park St.” The user can accept or decline this proposed alternate route using a verbal reply or by pressing a button on the user interface 20 of the personal navigation device 10. If a verbal response is given, the speech recognition software 38 can be used to decipher the user's answer. In the event that the user rejects the first proposed alternate route, a second proposed alternate can be given instead, with the user again being given the chance to accept or reject this choice. Once the user has accepted an alternate route, the routing software 34 will guide the user along the alternate route and then eventually to the user's ultimate destination location.

The present invention aims to simply the process of describing alternate routes by using the names of one or more streets that make up the alternate routes. Any number of street names can be used, but a smaller number of street names such as one to three is usually easiest for the user to understand. If only one street name is used to describe the alternate route, the user could be prompted with the following: “Heavy traffic up ahead on Main St. Do you want to get off on First Ave.?” If three street names are given, the user can be prompted with: “Heavy traffic up ahead on Main St. Do you want to detour via First Ave., Park St., and Second Ave.?”

The key requirement in stating the street names is that suitable street names that are recognizable to the user should be used. To accomplish this, the following criteria can be used in selecting street names to be mentioned when describing the alternate route.

If the name of a street associated with the alternate route appears in a signpost located nearby a current location of the personal navigation device, that street name can be used in the description of the alternate route. Signpost locations are already stored in the map database 32 stored in the memory 30 of the personal navigation device 10, so this information can easily be retrieved.

If a signpost showing the name of the first street of the alternate route will be visible from a road that the personal navigation device 10 is currently travelling on, then the that street name can be used in the description of the alternate route. In this way, the user can easily find the first street of the alternate route and can start following the rest of the alternate route.

If part of the alternate route involves travelling on a major street or road, then that street name can be used in the description of the alternate route. The map database 32 stores road classification data for each road in the databases, so it can be quickly determined if one of the streets in the alternate route is a major road. The user is more likely to be familiar with a major road, so this should be mentioned to the user when describing the alternate route.

If one of the streets that makes up part of the alternate route constitutes a major percentage of the alternate route, then that street name can be used in the description of the alternate route. For instance, if the percentage of the alternate route traveled on one street exceeds a predetermined percentage such as 50%, then that street name should be mentioned when describing the alternate route.

One or more of the above four rules can be applied when determining the street names that should be mentioned to the user when suggesting an alternate route to the user.

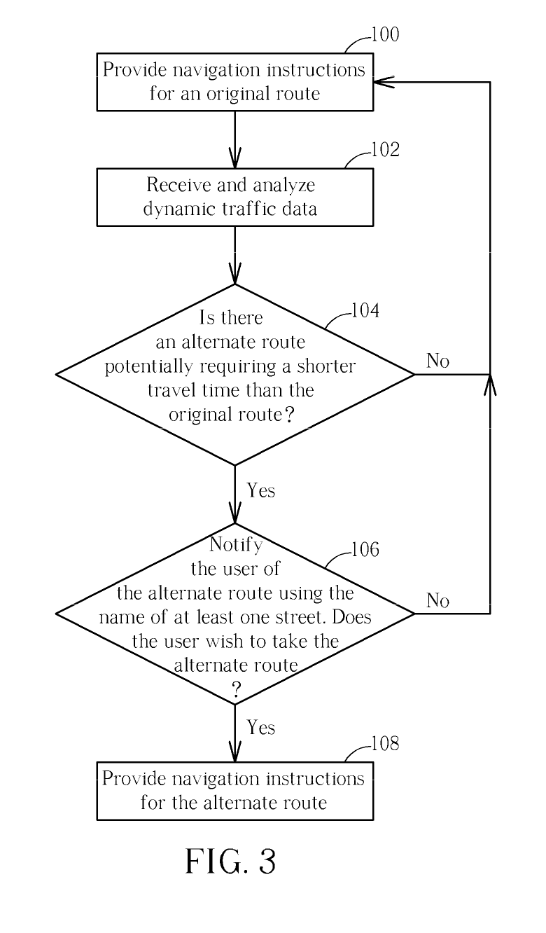

Please refer to FIG. 3. FIG. 3 is a flowchart illustrating providing alternate navigation instructions according to the present invention method. Steps contained in the flowchart will be explained below.

Step 100: Provide navigation instructions for guiding the user on an original route selected by the user.

Step 102: Receive and analyze dynamic traffic data.

Step 104: Determine if there is an alternate route potentially requiring a shorter travel time than the original route. If so, go to step 106. If not, go back to step 100.

Step 106: Notify the user of the alternate route using the name of at least one street, and ask if the user wishes to take the alternate route. If so, go to step 108. If not, go back to step 100.

Step 108: Provide the user with navigation instructions for the alternate route.

In summary, the more meaningful the street name is to the user for describing the alternate route, the better the user can make an informed decision about whether to accept the alternate route or not. When the driver can instantly picture the alternate route being described using the names of streets in the alternate route, the driver can quickly make a decision and reduce the amount of time and concentration needed to consider the alternate route. Not only does this save the user time, but it allows the user to maintain focus on the road, thereby allowing the user to safely choose an alternate route when the original route becomes less desirable.

Those skilled in the art will readily observe that numerous modifications and alterations of the device and method may be made while retaining the teachings of the invention.

What is claimed is:

1. A method of presenting alternate routes to a user of a personal navigation device, the method comprising:
providing navigation instructions for guiding the user on an original route selected by the user;
receiving and analyzing dynamic traffic data;
determining the presence of a first alternate route according to the dynamic traffic data, the first alternate route potentially requiring a shorter travel time than the original route; and
prompting the user with a choice of following the first alternate route, wherein the first alternate route is described using the name of at least one street associated with the first alternate route.

2. The method of claim 1 further comprising:
receiving a response from the user accepting the first alternate route; and
providing navigation instructions for following the first alternate route.

3. The method of claim 1 further comprising:
receiving a response from the user rejecting the first alternate route;
determining the presence of a second alternate route according to the dynamic traffic data; and
prompting the user with a choice of following the second alternate route, wherein the second alternate route is described using the name of at least one street associated with the second alternate route.

4. The method of claim 1, wherein the first alternate route is described using the names of two or more streets associated with the first alternate route.

5. The method of claim 1, wherein the name of the at least one street associated with the first alternate route represents a street whose name appears in a signpost located nearby a current location of the personal navigation device.

6. The method of claim 1, wherein the name of the at least one street associated with the first alternate route represents a first street that is part of the first alternate route, the name of the first street being visible from a road that the personal navigation device is currently traveling on.

7. The method of claim 1, wherein the name of the at least one street associated with the first alternate route represents a major street that is part of the first alternate route.

8. The method of claim 1, wherein the name of the at least one street associated with the first alternate route represents a street that constitutes a proportion of the first alternate route greater than a predetermined percentage of a total distance of the first alternate route.

9. The method of claim 1, wherein prompting the user with the choice of following the first alternate route comprises providing an audible prompt to the user, and receiving the response from the user comprises recognizing a spoken response given by the user.

10. The method of claim 1, wherein prompting the user with the choice of following the first alternate route comprises providing a visual prompt to the user, and receiving the response from the user comprises receiving a touch response given by the user.

11. A personal navigation device for presenting alternate routes to a user, the personal navigation device comprising:
routing software for providing navigation instructions for guiding the user on an original route selected by the user;
a processor for controlling operation of the personal navigation device, receiving and analyzing dynamic traffic data, and determining the presence of a first alternate route according to the dynamic traffic data, the first alternate route potentially requiring a shorter travel time than the original route; and
a user interface for prompting the user with a choice of following the first alternate route, wherein the first alternate route is described using the name of at least one street associated with the first alternate route.

12. The personal navigation device of claim 11, wherein when the user interface receives a response from the user accepting the first alternate route, the routing software provides navigation instructions for following the first alternate route.

13. The personal navigation device of claim 11, wherein when the user interface receives a response from the user rejecting the first alternate route, the processor determines the presence of a second alternate route according to the dynamic traffic data, and the user interface prompts the user with a choice of following the second alternate route, wherein the second alternate route is described using the name of at least one street associated with the second alternate route.

14. The personal navigation device of claim 11, wherein the first alternate route is described using the names of two or more streets associated with the first alternate route.

15. The personal navigation device of claim 11, wherein the name of the at least one street associated with the first alternate route represents a street whose name appears in a signpost located nearby a current location of the personal navigation device.

16. The personal navigation device of claim 11, wherein the name of the at least one street associated with the first alternate route represents a first street that is part of the first alternate route, the name of the first street being visible from a road that the personal navigation device is currently traveling on.

17. The personal navigation device of claim 11, wherein the name of the at least one street associated with the first alternate route represents a major street that is part of the first alternate route.

18. The personal navigation device of claim 11, wherein the name of the at least one street associated with the first alternate route represents a street that constitutes a proportion of the first alternate route greater than a predetermined percentage of a total distance of the first alternate route.

19. The personal navigation device of claim 11, wherein prompting the user with the choice of following the first alternate route comprises providing an audible prompt to the user, and receiving the response from the user comprises recognizing a spoken response given by the user.

20. The personal navigation device of claim 11, wherein prompting the user with the choice of following the first alternate route comprises providing a visual prompt to the user, and receiving the response from the user comprises receiving a touch response given by the user.
